(19) United States
(12) Patent Application Publication
(10) Pub. No.: US 2010/0143712 A1
(43) Pub. Date: Jun. 10, 2010

(54) SILANE-CROSSLINKING ADHESIVE OR SEALANT COMPRISING N-SILYLALKYLAMIDES AND USE THEREOF

(75) Inventors: Thomas Plantenberg, Duesseldorf (DE); Ralf Dunekake, Duesseldorf (DE); Klaus Helpenstein, Moenchengladbach (DE); Johann Klein, Duesseldorf (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/702,352

(22) Filed: Feb. 9, 2010

Related U.S. Application Data
(63) Continuation of application No. PCT/EP2008/060767, filed on Feb. 15, 2008.

(30) Foreign Application Priority Data
Aug. 15, 2007 (DE) 102007038661.5

(51) Int. Cl. C09J 201/10; C09J 175/04; C09J 167/00; C09J 173/00; C09J 133/12; C09J 171/00; B32B 27/32; B32B 27/34; B32B 27/36; B32B 27/40

(52) U.S. Cl. 428/355 CN; 525/326.5; 525/342; 525/431; 525/333.7; 525/333.6; 525/330.5; 525/453; 428/355 N; 428/447

(57) ABSTRACT

The invention relates to a silane-crosslinking adhesive or sealant containing a polymer that is made up of an organic backbone that carries at least two alkoxy- and/or acyloxysilyl groups, and at least one N-silylalkylamide as an additive. The invention also relates to use of the N-silylalkylamide as an additive in silane-crosslinking adhesives or sealants.

The present invention relates to a silane-crosslinking adhesive or sealant which contains a polymer having an organic backbone that contains as additives at least two alkoxy- or acyloxysilane groups, which can also be referred to as alkoxy- or acyloxysilyl groups, and N-silylalkylamides.

Silane-crosslinking adhesive and sealant compounds contain alkoxysilyl-terminated polymers as binders. Polymer systems that possess reactive alkoxysilyl groups have been known for some time. In the presence of atmospheric moisture these alkoxysilyl-terminated polymers are capable, even at room temperature, of condensing with one another with release of the alkoxy groups. What forms in this context, depending on the concentration of alkoxysilyl groups and their configuration, are principally long-chain polymers (thermoplastics), relative wide-mesh three-dimensional networks (elastomers), or highly crosslinked systems (thermosetting plastics).

The polymers generally comprise an organic backbone that carries alkoxysilyl groups or alkoxysilane groups. The organic backbone can involve, for example, polyurethanes, polyesters, polyethers, polyols, polyacrylates or -methacrylates, polyvinyl alcohols, etc.

WO 99/48942, for example, discloses a one-component reactive system composition that contains an alkoxysilyl-terminated polyurethane, a curing catalyst, and usual additives as applicable.

Elastic adhesive bonding requires adhesives that on the one hand exhibit high bond strengths but are also sufficiently elastic that they can permanently maintain the adhesive bond. As the strength of an adhesive is increased, a decrease in elastic properties usually also occurs. The greater strength is usually achieved by increasing the crosslinking density, but this simultaneously results in by a decrease in elasticity. Increasing the elasticity by adding a larger quantity of a plasticizer leads to the problem that migration also increases; this is generally an undesirable effect.

It is an object of the present invention to describe silane-crosslinking adhesives or sealants that have improved mechanical properties. The intention in particular is greatly to improve elongation at fracture (elasticity) while simultaneously increasing tensile and/or shear strength.

It has been found, surprisingly, that this object can be achieved by the use of N-silylalkylamides as additives.

The subject matter of the present invention is therefore a silane-crosslinking adhesive or sealant containing a polymer made up of an organic backbone that carries at least two alkoxy- and/or acyloxysilyl groups, which is characterized in that as further components, compounds of formula (I)

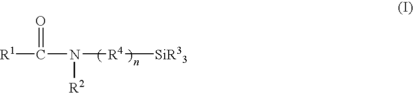

in which
R¹ is a straight-chain or branched, substituted or unsubstituted alkyl residue having 1 to 24 carbon atoms,
R² is a hydrogen residue or a straight-chain or branched hydrocarbon residue having 1 to 10 carbon atoms,
R³ is an alkoxy residue having 1 to 8 carbon atoms or an alkyl residue having 1 to 24 carbon atoms,
R⁴ is a straight-chain (or linear) or branched alkylene residue having 1 to 8 carbon atoms, in which carbon atoms can be substituted with nitrogen or oxygen atoms,
n=1 to 8, preferably n 3 to 8,
such that the residues R³ can each be the same or different, and at least two of the residues are alkoxy residues,
are contained as an additive.

A “silane-crosslinking” adhesive or sealant is to be understood as an adhesive or sealant, or an adhesive or sealant compound, that contains as a binder at least one alkoxysilyl- and/or acyloxysilyl-terminated polymer. According to the present invention, the polymer comprises an organic backbone, i.e. contains carbon atoms in the main chain. The compound of formula (I) used as an additive is referred to as an N-silylalkylamide.

According to a preferred embodiment, R² is a hydrogen, butyl, cyclohexyl, or phenyl residue, or a substituted or unsubstituted benzyl residue.

The double-bond residue —(R⁴)ₙ— is by preference an alkylene residue having 1 to 8 carbon atoms, preferably an alkylene residue having 1 to 4 carbon atoms, in particular a methylene, ethylene, propylene, or isobutylene residue. A propylene residue is particularly preferred.

R³ is by preference a methoxy, ethoxy, or alkyl residue having 1 to 24 carbon atoms. It is particularly preferred if R³ is represented by one or two ethoxy residues and an alkyl residue having 1 to 24 carbon atoms, or by three ethoxy residues. It is particularly preferred if the —Si(R³)₃ group is a dialkoxyalkylsilyl group, in particular a dimethoxyalkyl- or diethoxyalkylsilyl group, or a trialkoxysilyl group, in particular a trimethoxy- or triethoxysilyl group. Examples are dimethoxymethylsilyl, dimethoxyethylsilyl, diethoxymethylsilyl, diethoxyethylsilyl, trimethoxysilyl, and triethoxysilyl groups.

The additive of formula (I) possesses a very low viscosity, i.e. it improves strength and elongation but does not contribute to a buildup of viscosity. This is particularly advantageous for higher-viscosity systems because less plasticizer and/or solvent therefore needs to be introduced in order to compensate for viscosity buildup, or it can be entirely omitted.

R¹ is a straight-chain (or linear) or branched, substituted or unsubstituted alkyl residue having 1 to 24 carbon atoms.

R¹ is by preference an alkyl residue having 10 to 16 carbon atoms, which can contain OH groups or epoxy groups. Residues having 12 to 14 carbon atoms are particularly preferred. This is advantageous because the additives with R¹≦C₁₆ are liquid and can easily be incorporated. Additives with R¹>C₁₆ are waxy, and as a result are more poorly processable and tend to contribute to the buildup of an undesirably high viscosity in the binder.

If compounds in which R¹ represents a longer chain are used, the desired additive effect is achieved by means of substances that comprise less silane in absolute terms. The absolute number of additional network points (=network density), which contribute to an increase in viscosity, strength, and brittleness, is thus smaller. With a smaller number of network points, adhesives or sealants that are more elastic and more extensible can be obtained.

The N-silylalkylamides per se are known. WO 2004/037868 A1, for example, describes photocuring and moisture-curing silicone mixtures that contain α-silanes. In this patent application, organosilanols function as binders. The object of this patent is to make available fast-curing systems.

U.S. Pat. Nos. 4,695,603 and 4,788,310 describe silicone compositions that contain N-silylalkylamides. These systems comprise polyorganosiloxanes as a backbone.

The polymer contained as a binder in the adhesive or sealant according to the present invention advantageously corresponds to the general formula (II)

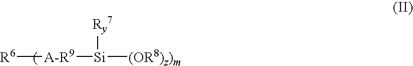

in which R⁶ is an organic backbone,
A signifies a double-bond bonding group, in particular an amide, carboxy, carbamate, carbonate, ureido, urethane, urea, carbamoyl, or sulfonate group or bond, an oxygen atom, a nitrogen or sulfur atom, or a methylene group,
R⁷ is an alkyl residue having 1 to 8 carbon atoms, in particular an alkyl residue having 1 to 4 carbon atoms, or is OR⁸,
R⁸ is an alkyl residue having 1 to 8 carbon atoms, in particular an alkyl residue having 1 to 4 carbon atoms, or an acyl residue having 1 to 8 carbon atoms, in particular an acyl residue having 1 to 4 carbon atoms,
R⁹ is a straight-chain or branched, substituted or unsubstituted alkylene residue having 1 to 8 carbon atoms,
y=0 to 2,
z=3−y, and
m=1 to 10,000,
such that the silyl residues -A-R⁹—Si(R⁷)_{y}(OR⁸)_{z} can be the same or different, and in the case of multiple residues R⁷ or R⁸, the latter can each be the same or different.

A “double-bond” or divalent bonding group A is understood as a double-bond chemical group that links the polymer framework or organic backbone R⁶ of the alkoxy- and/or acyloxysilane-terminated polymer to the R⁹ residue of the terminal group. The double-bond bonding group A can be formed, for example, upon manufacture' of the alkoxy- and/or acyloxysilane-terminated polymer, e.g. as a urethane group by reaction of a polyether functionalized with hydroxy groups and an isocyanato-functional alkoxysilane, or conversely by reaction between a polymer that comprises terminal isocyanate groups and a hydroxy-functional alkoxysilane, i.e. an alkoxysilane comprising terminal hydroxy groups. Urea groups can be obtained in similar fashion if a terminal primary or secondary amino group (on either the alkoxysilane or the polymer) is used, and this reacts with a terminal isocyanato group present in the respective reaction partner. This means that either an aminofunctional alkoxysilane is reacted with a polymer comprising terminal isocyanato groups, or a polymer substituted terminally with an amino group is caused to react with an isocyanato-functional alkoxysilane.

The divalent bonding group A can be both distinguishable and indistinguishable from structural features occurring in the underlying polymer framework. The latter case exists, for example, when it is identical to the linkage points of the repeating units of the polymer framework.

In a preferred embodiment of the composition according to the present invention, A is an amide, carbamate, urea, imino, carboxy or oxycarbonyl, carbamoyl, amidino, carbonate, ureido, urethane, sulfonate, or sulfinate group, or an oxygen, nitrogen, or sulfur atom, or a methylene group.

Urethane groups and urea groups are particularly preferred as a bonding group. Urethane and urea groups advantageously increase the strength of the polymer chains and of the entire crosslinked polymer because they can form hydrogen bridges.

The R⁹ residue is a double-bond or divalent hydrocarbon residue, optionally containing a heteroatom, having 1 to 8 carbon atoms. Oxygen (O) or nitrogen (N) can be contained, for example, as a heteroatom. The hydrocarbon residue can be a straight-chain or branched, substituted or unsubstituted alkylene residue; the alkylene residue can, for example, also be cyclic. R⁹ is preferably an alkylene residue having 1 to 4 carbon atoms, in particular a methylene, ethylene, propylene, or isobutylene residue. A propylene residue is particularly preferred.

R⁷ and R⁸ are by preference alkyl residues having 1 to 4 carbon atoms, in particular methyl or ethyl residues; R⁷ and R⁸ can each be the same or different. It is particularly preferred if the —Si(R⁷)_{y}(OR⁸)_{z} group is a dialkoxyalkylsilyl group, in particular a dimethoxyalkyl- or diethoxyalkylsilyl group, or a trialkoxysilyl group, in particular a trimethoxy- or triethoxysilyl group. Examples are dimethoxymethylsilyl, dimethoxyethylsilyl, diethoxymethylsilyl, diethoxyethylsilyl, trimethoxysilyl, and triethoxysilyl groups.

m is preferably 2 or 3, in particular 2.

The organic backbone R⁶ of the polymer contained in the silane-crosslinking adhesive or sealant according to the present invention is advantageously selected from the group encompassing polyamides, polyethers, polyesters such as e.g. polyethylene terephthalate and polybutylene terephthalate, polycarbonates, polyethylenes, polybutylenes, polystyrenes, polypropylenes, polyacrylates and poly(meth)acrylates, e.g. homo- and copolymers of maleic acid, acrylic acid, acrylates, methacrylates, acrylamides, salts thereof, and the like, as well as acrylates described in EP 1 271 670 A1, polyoxymethylene homo- and copolymers, polyurethanes, vinyl butyrates, vinyl polymers, e.g. polymers containing vinyl chloride and/or vinyl acetate, rayon, ethylene copolymers such as e.g. ethylene-vinyl acetate copolymers, ethylene-acrylic acid copolymers, ethylene-acrylate copolymers, organic rubbers, mixtures of different silylated polymers, such that the backbone can also contain silyl groups. Examples include polyethers based on ethylene oxide, propylene oxide, and tetrahydrofuran, polyacrylate, and polymethacrylate. Of the aforesaid polymer backbones, polyethers and polyurethanes are preferred. Polyethers based on polyethylene oxide and/or polypropylene oxide, in particular polypropylene glycol, are particularly preferred. Polymers that contain polyethers as a backbone exhibit a flexible and elastic structure in the polymer spine. Compositions that exhibit outstanding elastic properties can be manufactured therewith. Polyethers are not only flexible in their framework, but also at the same time strong. For example, they are not attacked or decomposed by water and bacteria and are therefore notable for relative stability (in contrast to polyesters) with respect to environmental influences. The polymer, made up of an organic backbone having carbon atoms in the main chain, contained in the silane-crosslinking adhesive or sealant according to the present invention, does not include inorganic polymers such as, for example, polyphosphates, polysilanes, polysiloxanes, polysulfides. The advantage of the embodiment according to the present invention, in particular of the use of polyurethanes and polyethers, as compared with silicone-based binders or other inorganic polymers, is good adhesion to a very wide variety of substrates, good spreadability, no contamination of the substrate with silicones, and the highly elastic framework structure.

According to a further preferred embodiment of the silane-crosslinking adhesive or sealant according to the present invention, the molecular weight Mₙ of the polymer framework R⁶ is between 3000 and 50,000 g/mol. Further particularly preferred molecular weight ranges are 5000 to 25,000 g/mol; 8000 to 19,000 g/mol are very particularly preferred, in particular 12,000 to 18,000 or 15,000 to 16,000 g/mol.

These molecular weights are particularly advantageous because compositions having these molecular weights exhibit viscosities that enable easy processability.

Very particularly preferably, polyoxyalkylenes, in particular polyethylene oxides or polypropylene oxides, that have a polydispersity PD of less than 2, preferably less than 1.5, are used.

The molecular weight Mₙ is understood as the arithmetically averaged molecular weight of the polymer. This, like the weight-averaged molecular weight M_{w}, can be determined by gel permeation chromatography (GPC, also SEC). This method is known to one skilled in the art. The polydispersity is derived from the average molecular weights M_{w} and Mₙ. It is calculated as PD=M_{w}/Mₙ.

Particularly advantageous viscoelastic properties can be achieved if polyoxyalkylene polymers that possess a narrow molecular-weight distribution, and therefore a low polydispersity, are used as polymeric backbones. These can be manufactured, for example, by so-called double metal cyanide catalysis (DMC catalysis). These polyoxyalkylene polymers are notable for a particularly narrow molecular weight distribution, a high average molecular weight, and a very small number of double bonds at the ends of the polymer chains.

Polyoxyalkylene polymers of this kind have a polydispersity PD (M_{w}/Mₙ) of at most 1.7.

Particularly preferred organic backbones are, for example, polyethers having a polydispersity from approximately 1.01 to approximately 1.3, in particular approximately 1.05 to approximately 1.18, for example approximately 1.08 to approximately 1.11 or approximately 1.12 to approximately 1.14.

In a preferred embodiment of the invention, these polyethers have an average molecular weight (Mₙ) of approximately 5000 to approximately 30,000 g/mol, in particular approximately 6000 to approximately 25,000. Polyethers having average molecular weights from approximately 10,000 to approximately 22,000, in particular having average molecular weights from approximately 12,000 to approximately 18,000 g/mol, are particularly preferred.

Mixtures of multiple polymers having different molecular weights Mₙ can also be used according to the present invention instead of pure polymers. In this case the statements with regard to polydispersity and molecular weight Mₙ are to be understood in such a way that, advantageously, each of the polymers on which the mixture is based exhibits a polydispersity in the preferred range, but the preferred molecular-weight ranges refer to the value averaged over the entire mixture of the polymers that are used.

The compounds of formula (I) that function as an additive can be manufactured from an ester of formula (III)

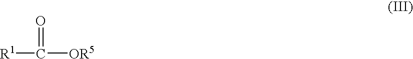

in which
R¹ is a straight-chain or branched, substituted or unsubstituted alkyl residue having 1 to 24 carbon atoms, preferably 10 to 16 carbon atoms, particularly preferably 12 to 14 carbon atoms, that can contain OH groups or epoxy groups, and
R⁵ is a methyl or ethyl residue,
and a silane of formula (IV)

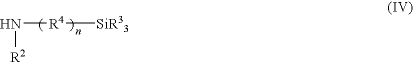

in which
R² is a hydrogen residue or a straight-chain or branched hydrocarbon residue having 1 to 10 carbon atoms, in particular a hydrogen, butyl, cyclohexyl, or phenyl residue, or a substituted or unsubstituted benzyl residue,
R³ is an alkoxy residue having 1 to 8 carbon atoms or an alkyl residue having 1 to 24 carbon atoms, in particular a methoxy, ethoxy, or alkyl residue having 1 to 24 carbon atoms,
R⁴ is a straight-chain (or linear) or branched alkylene residue having 1 to 8 carbon atoms, in which carbon atoms can be substituted with nitrogen or oxygen atoms,
n=1 to 8, preferably n=3 to 8,
such that the residues R³ can each be the same or different, and at least two of the residues are alkoxy residues.

The definitions of the residues and indices otherwise corresponding to the embodiments already described above.

Because the reaction is advantageously carried out in moderate vacuum in order to extract the alcohol (in particular ethanol or methanol) produced upon reaction, it is advantageous if the boiling point of the esters exceeds a certain minimum so that it is not distilled off with the byproduct (alcohol).

The esterified acids according to formula (III) are understood to be acids that contain one or more esterified carboxyl groups (—COOH). The carboxyl groups can be connected to saturated, unsaturated, and/or branched alkyl residues, by preference having more than 6 carbon atoms. They can contain further functional groups such as, for example, hydroxyl groups, keto groups, or epoxy groups.

The esterified fatty acids according to the present invention are preferably derived from natural fats and oils, for example rapeseed oil, sunflower oil, soybean oil, linseed oil, castor oil, coconut oil, palm oil, palm kernel oil, and beef tallow, which if applicable have been subjected to further derivatization (hydrogenation, epoxidation, dimerization, dehydrogenation, conjugation. The following may be recited as concrete examples: palmitoleic acid, oleic acid, elaidic acid, petroselic acid, eurcic acid, linoleic acid, linolenic acid, gadoleic acid, ricinoleic acid, 12-hydroxystearic acid, epoxystearic acid, isostearic acid, eurcic acid, dimer fatty acid, and trimer fatty acid. Esterified conjugated acids such as, for example, sorbic acid, 2,4-decadienoic acid, 2,4-dodecadienoic acid, 10,12-octadecadienoic acid, 9,11-octadecadienoic acid, 9-hydroxy-10,10-octadecadienoic acid, 13-hydroxy-9,11-octadecadienoic acid, 9,14-dihydroxy-10,12-octadecadienoic acid, 9,12,14-octadecatrienoic acid, 8,10,12-octadecatrienoic acid, elaeostearic acid, licanic acid, kamolenic acid, parinaric acid, isanic acid, isanolic acid, ximenynic acid, matricaria acid, lachnophyllic acid, mycomycinic acid are also usable.

Petrochemically manufactured acids, esterified in each case, such as octanoic acid, 2-ethylhexanoic acid, butyloctanoic acid, hexyldecanoic acid are also usable. Such fatty acids are obtainable, for example, from the Sasol company under the trade name Isocarb®.

The compounds of formula (IV) are by preference selected from the group made up of N-cyclohexylaminomethylmethyldiethoxysilane, N-cyclohexylaminomethyltriethoxysilane, N-phenylaminomethyltrimethoxysilane, N-(2-aminoethyl)-3-aminopropyltrimethoxysilane, N-(2-aminoethyl)-3-aminopropyltrimethoxysilane, N-cyclohexyl-3-aminopropyltrimethoxysilane, 3-aminopropyltriethoxysilane, N-(2-aminoethyl)-3-aminopropylmethyldimethoxysilane, 3-aminopropyltrimethoxysilane, 3-ureidopropyltrimethoxysilan, vinylbenzylaminoethylaminopropyltrimethoxysilane, aminopropyltriethoxysilane, aminoethylaminopropyltrimethoxysilane, aminoethylaminopropyltrimethoxysilane, aminoethylaminopropyltrimethoxysilane such as, for example, DOW CORNING® Z-6121 SI LANE of Dow, aminoethylaminopropylsilanetriol homopolymer such as, for example, DOW CORNING® Z-6137 SILANE of Dow, bis(3-triethoxysilylpropyl)amine, bis(3-trimethoxysilylpropyl)amine, oligoaminosilanes such as, for example, Dynasylan® 1133 of the Degussa company, aminosilane compositions such as, for example, Dynasylan® 1204, Dynasylan® AMEO-T, Dynasylan® SIVO 210, Dynasylin® DAMO-M, Dynasylin® DAMO-T of the Degussa company, 3-aminopropylmethyldiethoxysilane, 3-aminopropylmethyldiethoxysilane formulations such as, for example, Dynasylan® 1506 of the Degussa company, 3-aminopropyltriethoxysilane, 3-aminopropyltrimethoxysilane, aqueous siloxanes, VOC-free (i.e. free of volatile organic compounds) such as, for example, Dynasylan® HYDROSIL 1151, Dynasylan® HYDROSIL 2627, Dynasylan® HYDROSIL 2909, Dynasylan® HYDROSIL 2929, Dynasylan® HYDROSIL 2776 of the Degussa company, triaminofunctional propyltrimethoxysilanes such as, for example, Dynasylan® TRIAMO of the Degussa company, oligosiloxanes such as, for example, Dynasylan® 1146 of the Degussa company, N-(n-butyl)-3-aminopropyltrimethoxysilane, cationic benzylamino-functional silane hydrochloride such as, for example, Dynasylan® 1161 of the Degussa company, 2-aminoethyl-3-aminopropylmethyldimethoxysilane, 2-aminoethyl-3-aminopropyltrimethoxysilane, gamma-aminopropyltriethoxysilane, modified aminoorganosilanes such as, for example, Silquest® A-1108 of GE Silicones, gamma-aminopropyltrimethoxysilane, N-beta-(aminoethyl)-gamma-aminopropyltrimethoxysilane, modified aminoorganosilanes such as, for example, Silquest® A-1126 or A-1128 of GE Silicones, triamino-functional silanes such as, for example, Silquest® A-1130 of GE Silicones, bis-(gamma-trimethoxysilylpropyl)amine, polyazamidesilane such as, for example, Silquest® A-1387 of GE Silicones, delta-aminoneohexyltrimethoxysilane, N-beta-(aminoethyl)-gamma-aminopropylmethyldimethoxysilane, delta-aminoneohexylmethyldimethoxysilane, and N-phenyl-gamma-aminopropyltrimethoxysilane.

The molar ratio of the compounds of formula (III) to compounds of formula (IV) is by preference equal to 1:10 to 2:1. Particularly preferably, the molar ratio is equal to 7:10 to 7:5.

The proportion of compounds of formula (I) is equal to 0.1 to 50 percent by mass of the total binder content. The proportion is preferably equal to 5 to 30 percent by mass. Particularly preferably, the proportion is equal to 9 to 11 percent by mass of the total binder content. In the range from 0.1 to 50 percent by mass, the binder properties are not negatively modified by addition of the additive.

The total binder content of the adhesive or sealant is the total content of binders of the present invention.

According to a preferred embodiment, the adhesive or sealant according to the present invention contains a polymer, a vinylsilane, an aminosilane, an additive of formula (I), and a catalyst, as well as further additives as applicable. This means that the adhesive or sealant according to the present invention can contain, alongside the polymer and the additive of formula (I), a catalyst and further additives such as, for example, a vinylsilane or an aminosilane.

The aminosilane can be a silane of formula (IV), which can advantageously act as an adhesion promoter.

The further additives are adjuvants and additives that impart to the adhesives and sealants according to the present invention, for example, improved elastic properties, improved recovery capability, sufficiently long processing time, a rapid curing rate, and low residual tack. Included among these adjuvants and additives are adhesion promoters and plasticizers, as well as fillers. The compositions can moreover contain, as further additives, stabilizers, antioxidants, reactive diluents, drying agents, UV stabilizers, aging protectants, rheological adjuvants, color pigments or color pastes, fungicides, flameproofing agents, and/or also, if applicable, solvents in small quantities.

Suitable catalysts for controlling the curing speed of the adhesive and sealant according to the present invention are, for example, organometallic compounds such as iron or tin compounds, in particular the 1,3-dicarbonyl compounds of iron or of di- or tetravalent tin, the tin(II) carboxylates or dialkyltin(IV) dicarboxylates, or the corresponding dialkoxylates, e.g. dibutyltin dilaurate, dibutyltin diacetate, dioctyltin diacetate, dibutyltin maleate, tin(II) octoate, tin(II) phenolate, or the acetylacetonates of di- or tetravalent tin. It is also possible to use alkyl titanates, organosilicon titanium compounds, or bismuth tris-2-ethylhexanoate, acid compounds such as phosphoric acid, p-toluenesulfonic acid, or phthalic acid, aliphatic amines such as butylamine, hexylamine, octylamine, decylamine, or laurylamine, aliphatic diamines such as, for example, ethylenediamine, hexyldiamine, or also aliphatic polyamines such as diethylenetriamine, triethylenetetramine, tetraethylenepentamine, heterocyclic nitrogen compounds, e.g. piperidine, piperazine, aromatic amines such as m-phenylenediamine, ethanolamine, triethylamine, and other curing catalysts for epoxies.

Also suitable are the following tin compounds: di(n-butyl)tin(IV) di(methylmaleate), di(n-butyl)tin(IV) di(butylmaleate), di(n-octyl)tin(IV) di(methylmaleate), di(n-octyl)tin(IV) di(butylmaleate), di(n-octyl)tin(IV) di(isooctylmaleate), di(n-butyl)tin(IV) sulfide, di(n-butyl)tin(IV) oxide, di(n-octyl)tin(IV) oxide, (n-butyl)₂Sn(SCH₂COO), (n-octyl)₂Sn(SCH₂COO), (n-octyl)₂Sn(SCH₂CH₂COO), (n-octyl)₂Sn(SCH₂CH₂COOCH₂CH₂OCOCH₂S), (n-butyl)₂Sn(SCH₂COO-i-C₈H₁₇)₂, (n-octyl)₂Sn(SCH₂COO-i-C₈H₁₇)₂, (n-octyl)₂Sn(SCH₂COO-n-C₈H₁₇)₂.

Chelate-forming tin organyls can also be used, for example di(n-butyl)tin(IV) di(acetylacetonate), di(n-octyl)tin(IV) di(acetylacetonate), (n-octyl)(n-butyl)tin(IV) di(acetylacetonate).

Tin-free catalysts are also particularly preferred. Boron halides, such as boron trifluoride, boron trichloride, boron tribromide, boron triiodide, or mixed boron halides, can thus furthermore be used as curing catalysts. Boron trifluoride complexes such as, for example boron trifluoride diethyl etherate (CAS no. [109-63-71]), which, as liquids, are easier to handle than the gaseous boron halides, are particularly preferred.

By preference, compounds of titanium, aluminum, and zirconium, or mixtures of one or more catalysts from one or more of the groups just mentioned, can also be used. These catalysts are suitable as curing catalysts for the alkoxysilane polymers. One the one hand it is thereby possible to avoid the use of tin compounds; on the other hand, better adhesion to organic surfaces (for example, acrylates) that normally adhere poorly can thereby be improved. Among the titanium, aluminum, and zirconium catalysts, the titanium catalysts are preferred for use because the best curing results are obtained with them.

Compounds that comprise hydroxy groups and/or substituted or unsubstituted alkoxy groups are suitable as titanium catalysts, i.e. titanium alkoxides of the general formula

Ti(OR^{x})₄

where R^{x} is an organic group, by preference a substituted or unsubstituted hydrocarbon group having 1 to 20 carbon atoms, and the four —OR^{x} alkoxy groups are identical or different. One or more of the —OR^{x} residues can also be replaced by acyloxy groups —OCOR^{x}.

Also suitable as titanium catalysts are titanium alkoxides in which one or more alkoxy groups are replaced by halogen atoms.

The following mixed-substituted or non-mixed-substituted titanium alkoxides can be used, for example, as titanium catalysts: tetramethoxy titanium, tetraethoxy titanium, tetraallyloxy titanium, tetra-n-propoxy titanium, tetraisopropoxy titanium, tetra-n-butoxy titanium, tetraisobutoxy titanium, tetra-(2-butoxy) titanium, tetra(t-butoxy) titanium, tetrapentoxy (titanium), tetracyclopentoxy titanium, tetrahexoxy titanium, tetracyclohexoxy titanium, tetrabenzoxy titanium, tetraoctoxy titanium, tetrakis(2-ethylhexoxy) titanium, tetradecoxy titanium, tetradodecoxy titanium, tetrastearoxy titanium, tetrabutoxy titanium dimer, tetrakis(8-hydroxyoctoxy) titanium, titanium diisopropoxy-bis(2-ethyl-1,3-hexanediolate), titanium bis(2-ethylhexyloxy)bis(2-ethyl-1,3-hexanediolate), tetrakis(2-chloroethoxy) titanium, tetrakis(2-bromoethoxy) titanium, tetrakis(2-methoxyethoxy) titanium, tetrakis(2-ethoxyethoxy) titanium, butoxytrimethoxy titanium, dibutoxydimethoxy titanium, butoxytriethoxy titanium, dibutoxydiethoxy titanium, butoxytriisopropoxy titanium, dibutoxydiisopropoxy titanium, tetraphenoxybutane, tetrakis(o-chlorophenoxy) titanium, tetrakis(m-nitrophenoxy) titanium, tetrakis(p-methylphenoxy) titanium, tetrakis(trimethylsiloxy) titanium.

Titanium acylates can also be used: triisopropoxy titanium, triisopropoxy titanium methacrylate, diisopropoxy titanium dimethacrylate, isopropoxy titanium trimethacrylate, triisopropoxy titanium hexanoate, triisopropoxy titanium stearate, and the like.

The following compounds, for example, can be used as halogenated titanium catalysts: triisopropoxy titanium chloride, diisopropoxy titanium dichloride, isopropoxy titanium trichloride, triisopropoxy titanium bromide, triisopropoxy titanium fluoride, triethoxy titanium chloride, tributoxy titanium chloride.

Titanium chelate complexes can also be used: dimethoxy titanium bis(ethylacetoacetate), dimethoxy titanium bis(acetylacetonate), diethoxy titanium bis(ethylacetoacetate), diethoxy titanium bis(acetylacetonate), diisopropoxy titanium bis(ethylacetoacetate), diisopropoxy titanium bis(methylacetoacetate), diisopropoxy titanium bis(t-butylacetoacetate), diisopropoxy titanium bis(methyl-3-oxo-4,4-dimethylhexanoate), diisopropoxy titanium bis(ethyl-3-oxo-4,4,4-trifluorobutanoate), diisopropoxy titanium bis(acetylacetonate), diisopropoxy titanium bis(2,2,6,6-tetramethyl-3,5-heptanedionate), di(n-butoxy) titanium bis(ethylacetoacetate), di(n-butoxy) titanium bis(acetylacetonate), diisobutoxy titanium bis(ethylacetoacetate), diisobutoxy titanium bis(acetylacetonate), di(t-butoxy) titanium bis(ethylacetoacetate), di(t-butoxy) titanium bis(acetylacetonate), di(2-ethylhexoxy) titanium bis(ethylacetoacetate), di(2-ethylhexoxy) titanium bis(acetylacetonate), bis(1-methoxy-2-propoxy) titanium bis(ethylacetoacetate), bis(3-oxo-2-butoxy) titanium bis(ethylacetoacetate), bis(3-diethylaminopropoxy) titanium bis(ethylacetoacetate), triisopropoxy titanium (ethylacetoacetate), triisopropoxy titanium (diethylmalonate), triisopropoxy titanium (allylacetoacetate), triisopropoxy titanium (methacryloxyethylacetoacetate), 1,2-dioxyethane titanium bis(ethylacetoacetate), 1,3-dioxypropane titanium bis(ethylacetoacetate), 2,4-dioxypentane titanium bis(ethylacetoacetate), 2,4-dimethyl-2,4-dioxypentane titanium bis(ethylacetoacetate), diisopropoxy titanium bis(triethanolaminate), tetrakis(ethylacetoacetato) titanium, tetrakis(acetylacetonato) titanium, bis(trimethylsiloxy) titanium bis(ethylacetoacetate), bis(trimethylsiloxy) titanium bis(acetylacetonate).

It is preferred to use the following titanium chelate complexes, because they are commercially obtainable and have a high catalytic activity: diethoxy titanium bis(ethylacetoacetate), diethoxy titanium bis(acetylacetonate), diisopropoxy titanium bis(ethylacetoacetate), diisopropoxy titanium bis(acetylacetonate), dibutoxy titanium bis(ethylacetoacetate), and dibutoxy titanium bis(acetylacetonate).

Diethoxy titanium bis(ethylacetoacetate), diisopropoxy titanium (ethylacetoacetate), and dibutoxy titanium bis(ethylacetoacetate) are particularly preferred; diisopropoxy titanium bis(ethylacetoacetate) is very particularly preferred.

The following titanium catalysts can also be used: isopropoxy titanium tris(dioctylphosphate), isopropoxy titanium tris(dodecyl benzyl sulfonate), dihydroxy titanium bislactate.

Aluminum catalysts can also be used as curing catalysts, for example aluminum alkoxides

Al(OR^{x})₃,

where R^{x} denotes an organic group, preferably a substituted or unsubstituted hydrocarbon residue having 1 to 20 carbon atoms, and the three R^{x} residues are identical or different.

In the case of the aluminum alkoxides as well, one or more of the alkoxy residues can again be replaced by acyloxy residues —OC(O)R^{x}.

It is also possible to use aluminum alkoxides in which one or more alkoxy residues are replaced by halogen groups.

Of the aluminum catalysts described, the pure aluminum alcoholates are preferred in view of their stability with respect to moisture and the curability of the mixtures to which they are added. Aluminum chelate complexes are also preferred.

The following compounds, for example, can be used as aluminum alkoxides: trimethoxy aluminum, triethoxy aluminum, triallyloxy aluminum, tri(n-propoxy) aluminum, triisopropoxy aluminum, tri(n-butoxy) aluminum, triisobutoxy aluminum, tri(sec-butoxy) aluminum, tri(t-butoxy) aluminum, tri(n-pentoxy) aluminum, tricyclopentoxy aluminum, trihexoxy aluminum, tricyclohexoxy aluminum, tribenzoxy aluminum, trioctoxy aluminum, tris(2-ethylhexoxy) aluminum, tridecoxy aluminum, tridodecoxy aluminum, tristearoxy aluminum, dimeric tributoxy aluminum, tris(8-hydroxyoctoxy) aluminum, isopropoxy aluminum bis(2-ethyl-1,3-hexandiolate), diisopropoxy aluminum (2-ethyl-1,3-hexanediolate), (2-ethylhexoxy) aluminum bis(2-ethyl-1,3-hexanediolate), bis(2-ethylhexyloxy) aluminum (2-ethyl-1,3-hexanediolate), tris(2-chloroethoxy) aluminum, tris(2-bromoethoxy) aluminum, tris(2-methoxyethoxy) aluminum, tris(2-ethoxyethoxy) aluminum, butoxydimethoxy aluminum, methoxydibutoxy aluminum, butoxydiethoxy aluminum, ethoxydibutoxy aluminum, butoxydiisopropoxy aluminum, isopropoxydibutoxy aluminum, triphenoxy aluminum, tris(o-chlorophenoxy) aluminum, tris(m-nitrophenoxy) aluminum, tris(p-methylphenoxy) aluminum.

Aluminum acylates, for example, can also be used: diisopropoxy aluminum acrylate, diisopropoxy aluminum methacrylate, isopropoxy aluminum dimethacrylate, diisopropoxy aluminum hexanoate, diisopropoxy aluminum stearate.

Aluminum halide compounds can also be used, for example diisopropoxy aluminum chloride, isopropoxy aluminum dichloride, diisopropoxy aluminum bromide, diisopropoxy aluminum fluoride, diethoxy aluminum chloride, dibutoxy aluminum chloride.

Aluminum chelate complexes can also be used as catalysts, for example methoxy aluminum bis(ethylacetoacetate), methoxy aluminum bis(acetylacetonate), ethoxy aluminum bis(ethylacetoacetate), ethoxy aluminum bis(acetylacetonate), isopropoxy aluminum bis(ethylacetoacetate), isopropoxy aluminum bis(methylacetoacetate), isopropoxy aluminum bis(t-butylacetoacetate), dimethoxy aluminum (ethylacetoacetate), dimethoxy aluminum (acetylacetonate), diethoxy aluminum (ethylacetoacetate), diethoxy aluminum (acetylacetonate), diisopropoxy aluminum (ethylacetoacetate), diisopropoxy aluminum (methylacetoacetate), diisopropoxy aluminum (t-butylacetoacetate), isopropoxy aluminum bis(methyl-3-oxo-4,4-dimethylhexanoate), isopropoxy aluminum bis(ethyl-3-oxo-4,4,4-trifluoropentanoate), isopropoxy aluminum bis(acetylacetonate), isopropoxy aluminum bis(2,2,6,6-tetramethyl-3,5-heptanedionate), n-butoxy aluminum bis(ethylacetoacetate), n-butoxy aluminum bis(acetylacetonate), isobutoxy aluminum bis(ethylacetoacetate), isobutoxy aluminum bis(acetylacetonate), t-butoxy aluminum bis(ethylacetoacetate), t-butoxy aluminum bis(acetylacetonate), 2-ethylhexoxy aluminum bis(ethylacetoacetate), 2-ethylhexoxy aluminum bis(acetylacetonate), 1,2-dioxyethane aluminum (ethylacetoacetate), 1,3-dioxypropane aluminum (ethylacetoacetate), 2,4-dioxypentane aluminum (ethylacetoacetate), 2,4-dimethyl-2,4-dioxypentane aluminum (ethylacetoacetate), isopropoxy aluminum bis(triethanolaminate), aluminum tris(ethylacetoacetate), aluminum tris(acetylacetonate), aluminum (acetylacetonate) bis(ethylacetoacetate).

The following aluminum chelate complexes are used in preferred fashion as catalysts, because they are commercially obtainable and exhibit high catalytic activities: ethoxy aluminum bis(ethylacetoacetate), ethoxy aluminum bis(acetylacetonate), isopropoxy aluminum bis(ethylacetoacetate), isopropoxy aluminum bis(acetylacetonate), butoxy aluminum bis(ethylacetoacetate), butoxy aluminum bis(acetylacetonate), dimethoxy aluminum ethylacetoacetate, dimethoxy aluminum acetylacetonate, diethoxy aluminum ethylacetoacetate, diethoxy aluminum acetylacetonate, diisopropoxy aluminum ethylacetoacetate, diisopropoxy aluminum methylacetoacetate, and diisopropoxy aluminum (t-butylacetoacetate).

Ethoxy aluminum bis(ethylacetoacetate), isopropoxy aluminum bis(ethylacetoacetate), butoxy aluminum bis(ethylacetoacetate), dimethoxy aluminum ethylacetoacetate, diethoxy aluminum ethylacetoacetate, and diisopropoxy aluminum ethylacetoacetate are particularly preferred.

Isopropoxy aluminum bis(ethylacetoacetate) and diisopropoxy aluminum ethylacetoacetate are very particularly preferred.

The following aluminum catalysts, for example, can also be used: bis(dioctylphosphato)isopropoxy aluminum, bis(dodecylbenzylsulfonato)isopropoxy aluminum, hydroxy aluminum bislactate.

The following are suitable as zirconium catalysts: tetramethoxy zirconium, tetraethoxy zirconium, tetraallyloxy zirconium, tetra-n-propoxy zirconium, tetraisopropoxy zirconium, tetra-n-butoxy zirconium, tetraisobutoxy zirconium, tetra-(2-butoxy) zirconium, tetra(t-butoxy) zirconium, tetrapentoxy(zirconium), tetracyclopentoxy zirconium, tetrahexoxy zirconium, tetracyclohexoxy zirconium, tetrabenzoxy zirconium, tetraoctoxy zirconium, tetrakis(2-ethylhexoxy) zirconium, tetradecoxy zirconium, tetradodecoxy zirconium, tetrastearoxy zirconium, tetrabutoxy zirconium dimer, tetrakis(8-hydroxyoctoxy) zirconium, zirconium diisopropoxy-bis(2-ethyl-1,3-hexanediolate), zirconium bis(2-ethylhexyloxy)bis(2-ethyl-1,3-hexanediolate), tetrakis(2-chloroethoxy) zirconium, tetrakis(2-bromoethoxy) zirconium, tetrakis(2-methoxyethoxy) zirconium, tetrakis(2-ethoxyethoxy) zirconium, butoxytrimethoxy zirconium, dibutoxydimethoxy zirconium, butoxytriethoxy zirconium, dibutoxydiethoxy zirconium, butoxytriisopropoxy zirconium, dibutoxydiisopropoxy zirconium, tetraphenoxybutane, tetrakis(o-chlorophenoxy) zirconium, tetrakis(m-nitrophenoxy) zirconium, tetrakis(p-methylphenoxy) zirconium, tetrakis(trimethylsiloxy) zirconium, diisopropoxy zirconium bis(ethylacetoacetate), diisopropoxy zirconium bis(acetylacetonate), dibutoxy zirconium bis(ethylacetoacetate), dibutoxy zirconium bis(acetylacetonate), triisopropoxy zirconium ethylacetoacetate, triisopropoxy zirconium acetylacetonate, tris(n-butoxy) zirconium ethylacetoacetate, tris(n-butoxy) zirconium acetylacetonate, isopropoxy zirconium tris(ethylacetoacetate), isopropoxy zirconium tris(acetylacetonate), n-butoxy zirconium tris(ethylacetoacetate), n-butoxy zirconium tris(acetylacetonate), n-butoxy zirconium (acetylacetonate) bis(ethylacetoacetate).

It is preferred to use, for example, diethoxy zirconium bis(ethylacetoacetate), diisopropoxy zirconium bis(ethylacetoacetate), dibutoxy zirconium bis(ethylacetoacetate), triispropoxy zirconium (ethylacetoacetate), tris(n-butoxy) zirconium (ethylacetoacetate), isopropoxy zirconium tris(ethylacetoacetate), n-butoxy zirconium tris(ethylacetoacetate), and n-butoxy zirconium (acetylacetonate) bis(ethylacetoacetate).

Very particularly preferably, diisopropoxy zirconium bis(ethylacetoacetate), triispropoxy zirconium (ethylacetoacetate), and isopropoxy zirconium tris(ethylacetoacetate) can be.

Zirconium acylates, for example, can also be used: triisopropoxy zirconium, triisopropoxy zirconium methacrylate, diisopropoxy zirconium dimethacrylate, isopropoxy zirconium trimethacrylate, triisopropoxy zirconium hexanoate, triisopropoxy zirconium stearate, and the like.

The following compounds can be used as halogenated zirconium catalysts: triisopropoxy zirconium chloride, diisopropoxy zirconium dichloride, isopropoxy zirconium trichloride, triisopropoxy zirconium bromide, triisopropoxy zirconium fluoride, triethoxy zirconium chloride, tributoxy zirconium chloride.

Zirconium chelate complexes can also be used: dimethoxy zirconium bis(ethylacetoacetate), dimethoxy zirconium bis(acetylacetonate), diethoxy zirconium bis(ethylacetoacetate), diethoxy zirconium bis(acetylacetonate), diisopropoxy zirconium bis(ethylacetoacetate), diisopropoxy zirconium bis(methylacetoacetate), diisopropoxy zirconium bis(t-butylacetoacetate), diisopropoxy zirconium bis(methyl-3-oxo-4,4-dimethylhexanoate), diisopropoxy zirconium bis(ethyl-3-oxo-4,4,4-trifluorobutanoate), diisopropoxy zirconium bis(acetylacetonate), diisopropoxy zirconium bis(2,2,6,6-tetramethyl-3,5-heptanedionate), di(n-butoxy) zirconium bis(ethylacetoacetate), di(n-butoxy) zirconium bis(acetylacetonate), diisobutoxy zirconium bis(ethylacetoacetate), diisobutoxy zirconium bis(acetylacetonate), di(t-butoxy) zirconium bis(ethylacetoacetate), di(t-butoxy) zirconium bis(acetylacetonate), di(2-ethylhexoxy) zirconium bis(ethylacetoacetate), di(2-ethylhexoxy) zirconium bis(acetylacetonate), bis(1-methoxy-2-propoxy) zirconium bis(ethylacetoacetate), bis(3-oxo-2-butoxy) zirconium bis(ethylacetoacetate), bis(3-diethylaminopropoxy) zirconium bis(ethylacetoacetate), triisopropoxy zirconium (ethylacetoacetate), triisopropoxy zirconium (diethylmalonate), triisopropoxy zirconium (allylacetoacetate), triisopropoxy zirconium (methacryloxyethylacetoacetate), 1,2-dioxyethane zirconium bis(ethylacetoacetate), 1,3-dioxypropane zirconium bis(ethylacetoacetate), 2,4-dioxwentane zirconium bis(ethylacetoacetate), 2,4-dimethyl-2,4-dioxypentane zirconium bis(ethylacetoacetate), diisopropoxy zirconium bis(triethanolaminate), tetrakis(ethylacetoacetato) zirconium, tetrakis(acetylacetonato) zirconium, bis(trimethylsiloxy) zirconium bis(ethylacetoacetate), bis(trimethylsiloxy) zirconium bis(acetylacetonate).

The following zirconium chelate complexes are preferred for use because they are commercially obtainable and have a high catalytic activity: diethoxy zirconium bis(ethylacetoacetate), diethoxy zirconium bis(acetylacetonate), diisopropoxy zirconium bis(ethylacetoacetate), diisopropoxy zirconium bis(acetylacetonate), dibutoxy zirconium bis(ethylacetoacetate) and dibutoxy zirconium bis(acetylacetonate).

Diethoxy zirconium bis(ethylacetoacetate), diisopropoxy zirconium (ethylacetoacetate), and dibutoxy zirconium bis(ethylacetoacetate) are particularly preferred; diisopropoxy zirconium bis(ethylacetoacetate) is very particularly preferred.

The following zirconium catalysts can also be used: isopropoxy zirconium tris(dioctylphosphate), isopropoxy zirconium tris(dodecyl benzyl sulfonate), dihydroxy zirconium bislactate.

Carboxylic acid salts of metals, or a mixture of multiple such salts, can furthermore be employed as curing catalysts, these being selected from the carboxylates of the following metals: calcium, vanadium, iron, titanium, potassium, barium, manganese, nickel, cobalt, and/or zirconium.

Of the carboxylates, the calcium, vanadium, iron, titanium, potassium, barium, manganese, and zirconium carboxylates are preferred because they have a high activity.

Calcium, vanadium, iron, titanium, and zirconium carboxylates are particularly preferred.

Iron and titanium carboxylates are very particularly preferred.

The following compounds, for example, can be used: iron(II) (2-ethylhexanoate), iron(III) (2-ethylhexanoate), titanium(IV) (2-ethylhexanoate), vanadium(III) (2-ethylhexanoate), calcium(II) (2-ethylhexanoate), potassium 2-ethylhexanoate, barium(II) (2-ethylhexanoate), manganese(II) (2-ethylhexanoate), nickel(II) (2-ethylhexanoate), cobalt(II) (2-ethylhexanoate), zirconium(IV) (2-ethylhexanoate), iron(II) neodecanoate, iron(III) neodecanoate, titanium(IV) neodecanoate, vanadium(III) neodecanoate, calcium(II) neodecanoate, potassium neodecanoate, barium(II) neodecanoate, zirconium(IV) neodecanoate, iron(II) oleate, iron(III) oleate, titanium tetraoleate, vanadium(III) oleate, calcium(II) oleate, potassium oleate, barium(II) oleate, manganese(II) oleate, nickel(II) oleate, cobalt(II) oleate, zirconium(IV) oleate, iron(II) naphthenate, iron(III) naphthenate, titanium(IV) naphthenate, vanadium(III) naphthenate, calcium dinaphthenate, potassium naphthenate, barium dinaphthenate, manganese dinaphthenate, nickel dinaphthenate, cobalt dinaphthenate, zirconium(IV) naphthenate.

In terms of catalytic activity, iron(II) 2-ethylhexanoate, iron(III) 2-ethylhexanoate, titanium(IV) 2-ethylhexanoate, iron(II) neodecanoate, iron(III) neodecanoate, titanium(IV) neodecanoate, iron(II) oleate, iron(III) oleate, titanium(IV) oleate, iron(II) naphthenate, iron(III) naphthenate, and titan(IV) naphthenate are preferred, and iron(III) 2-ethylhexanoate, iron(III) neodecanoate, iron(III) oleate, and iron(III)naphthenate are particularly preferred.

The following are preferred in terms of the nonoccurrence of discolorations: titanium(IV) 2-ethylhexanoate, calcium(II) 2-ethylhexanoate, potassium 2-ethylhexanoate, barium(II) 2-ethylhexanoate, zirconium(IV) 2-ethylhexanoate, titanium(IV) neodecanoate, calcium(II) neodecanoate, potassium neodecanoate, barium(II) neodecanoate, zirconium(IV) neodecanoate, titanium(IV) oleate, calcium(II) oleate, potassium oleate, barium(II) oleate, zirconium(IV) oleate, titanium(IV) naphthenate, calcium(II) naphthenate, potassium naphthenate, barium(II) naphthenate, and zirconium(IV) naphthenate.

The calcium carboxylates, vanadium carboxylates, iron carboxylates, titanium carboxylates, potassium carboxylates, barium carboxylates, manganese carboxylates, nickel carboxylates, cobalt carboxylates, and zirconium carboxylates can be used individually or as a mixture of several catalysts from one or more of the aforementioned groups. These metal carboxylates can furthermore be used in conjunction with tin carboxylates, lead carboxylates, bismuth carboxylates, and cerium carboxylates.

The catalyst, preferably mixtures of several catalysts, are used in a quantity from 0.01 to approximately 5 percent by mass, based on the total weight of the preparation or of the adhesive or sealant according to the present invention.

The adhesive or sealant can additionally contain fillers such as those that have hitherto been used in the existing art. Suitable here are, for example, chalk, sand, lime powder, precipitated and/or pyrogenic silicic acid, zeolites, bentonites, magnesium carbonate, diatomite, alumina, clay, talc, titanium oxide, iron oxide, zinc oxide, quartz, flint, mica, and other ground mineral substances. Organic fillers can also be used, in particular carbon black, graphite, wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added. Aluminum powder is likewise suitable as a filler.

The pyrogenic and precipitated silicic acids advantageously have a BET surface area from 10 to 90 m²/g. This additive does not act to increase viscosity when added to the binder, but does strengthen the adhesive or sealing bond once cured. If silicic acid having a BET surface area between 90 to 250 m²/g, by preference 100 to 200 m²/g, is used (likewise advantageously), it acts like a thickener, i.e. the viscosity increases as more is added. The addition of such fillers advantageously brings about a strengthening of the adhesive or sealing bond after curing. If silicic acid having a greater BET surface area is used, the higher specific surface area means that the same effect is achieved with less added filler, as compared with silicic acid having a smaller BET surface area. Because less filler thus needs to be added, more leeway remains in the formulation for optimizing it by adding further additives.

Glass powder is further suitable as a filler.

Also suitable as fillers are hollow spheres having a mineral shell or a plastic shell. These can be, for example, hollow glass spheres that are obtainable commercially under the trade names Expancel® or Dualite®. Plastic-based hollow spheres are described e.g. in EP 0 520 426 B1. They are made up of inorganic or organic substances and each have a diameter of 1 mm or less, preferably 500 μm or less.

Fillers that impart thixotropy to the preparations are preferred for many applications, e.g. hydrogenated castor oil, fatty acid amides, or swellable plastics such as PVC. In order to be readily squeezable out of a suitable dispensing apparatus (e.g. a tube), such compositions possess a viscosity from 5000 to 200,000, preferably 20,000 to 150,000 mPas, and particularly preferably 40,000 to 100,000 (determined per DIN 53019 using a Brookfield RVT, 25° C., 50 rpm, ball-plate geometry, ball diameter 25 mm, opening angle 2.3° (=0.04 rad)).

As further constituents or additives, the adhesive or sealant according to the present invention can contain the reactive diluents, plasticizers, solvents, UV stabilizers, antioxidants, drying agents, and adhesion promoters known in the existing art.

It is also conceivable for the viscosity of the adhesive or sealant according to the present invention to be too high for certain applications. This can then as a rule be reduced adjusted in simple and appropriate fashion by using a reactive diluent, without causing demixing phenomena (e.g. plasticizer migration) in the cured substance.

The reactive diluent by preference comprises at least one functional group that reacts after application with, for example, moisture or atmospheric oxygen. Examples of such groups are silyl groups, isocyanate groups, vinylically unsaturated groups, and polyunsaturated systems.

All compounds that are miscible with the adhesive or sealant with a reduction in viscosity, and that possess at least one group that is reactive with the binder, can be used as reactive diluents.

The viscosity of the reactive diluent is preferably equal to less than 20,000 mPas, particularly preferably approximately 0.1 to 6000 mPas, very particularly preferably 1 to 1000 mPas (Brookfield RVT, 23° C., spindle 7, 10 rpm, in a 600 ml beaker (low shape, diameter 83 mm)).

The following substances can be used, for example, as reactive diluents: polyalkylene glycols reacted with isocyanatosilanes or isocyanato-functional alkoxysilanes (e.g. Synalox 100-50B, Dow), carbamatopropyltrimethoxysilane, alkyltrimethoxysilane, alkyltriethoxysilane, such as methyltrimethoxysilane, methyltriethoxysilane, and vinyltrimethoxysilane (XL 10, Wacker), vinyltriethoxysilane, phenyltrimethoxysilane, phenyltriethoxysilane, octyltrimethoxysilane, tetraethoxysilane, vinyldimethoxymethylsilane (XL12, Wacker), vinyltriethoxysilane (GF56, Wacker), vinyltriacetoxysilane (GF62, Wacker), isooctyltrimethoxysilane (IO Trimethoxy), isooctyltriethoxysilane (IO Triethoxy, Wacker), N-trimethoxysilylmethyl-O-methyl carbamate (XL63, Wacker), N-dimethoxy(methyl)silylmethyl-O-methyl carbamate (XL65, Wacker), hexadecyltrimethoxysilane, 3-octanoylthio-1-propyltriethoxysilane, and partial hydrolysates of said compounds.

Also usable as reactive diluents are the following polymers of Kaneka Corp.: MS S203H, MS S303H, MS SAT 010, and MS SAX 350.

Silane-modified polymers that are derived, for example, from the reaction of isocyanatoalkoxysilane with Synalox grades can likewise be used.

Polymers that can be manufactured from an organic backbone by grafting with a vinylsilane, or by reaction with polyol, polyisocyanate, and alkoxysilane, can furthermore be used as reactive diluents.

A “polyol” is understood as a compound that can contain one or more OH groups in the molecule. The OH groups can be both primary and secondary.

Included among the suitable aliphatic alcohols are, for example, ethylene glycol, propylene glycol, and higher glycols, as well as other polyfunctional alcohols. The polyols can additionally contain further functional groups such as, for example, esters, carbonates, amides.

For manufacture of the reactive diluents preferred according to the present invention, the corresponding polyol component is reacted respectively with an at least difunctional isocyanate. Any isocyanate having at least two isocyanate groups is appropriate in principle as an at least difunctional isocyanate, but compounds having two to four isocyanate groups, in particular having two isocyanate groups, are generally preferred in the context of the present invention.

The compound present as a reactive diluent in the context of the present invention preferably comprises at least one alkoxysilyl group, the di- and trialkoxysilyl groups being preferred among the alkoxysilyl groups.

Suitable polyisocyanates for manufacturing a reactive diluent are, for example, ethylene diisocyanate, 1,4-tetramethylene diisocyanate, 1,4-tetramethoxybutane diisocyanate, 1,6-hexamethylene diisocyanate (HDI), cyclobutane 1,3-diisocyanate, cyclohexane 1,3- and 1,4-diisocyanate, bis(2-isocyanatoethyl) fumarate, as well as mixtures of two or more thereof, 1-isocyanato-3,3,5-trimethyl-5-isocyanatomethylcyclohexane (isophorone diisocyanate, IPDI), 2,4- and 2,6-hexahydrotoluoylene diisocyanate, hexahydro-1,3- or -1,4-phenylene diisocyanate, benzidine diisocyanate, naphthalene 1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluoylene diisocyanate (TDI), 2,4′-diphenylmethane diisocyanate, 2,2′-diphenylmethane diisocyanate, or 4,4′-diphenylmethane diisocyanate (MDI), or partially or completely hydrogenated cycloalkyl derivatives thereof, for example completely hydrogenated MDI (H12-MDI), alkyl-substituted diphenylmethane diisocyanates, for example mono-, di-, tri-, or tetraalkyldiphenylmethane diisocyanate as well as partially or completely hydrogenated cycloalkyl derivatives thereof, 4,4′-diisocyanatophenylperfluorethane, phthalic acid bisisocyanatoethyl ester, 1-chloromethylphenyl-2,4- or -2,6-diisocyanate, 1-bromomethylphenyl-2,4- or -2,6-diisocyanate, 3,3-bischloromethyl ether-4,4′-diphenyldiisocyanate, sulfur-containing diisocyanates such as those obtainable by reacting 2 mol diisocyanate with 1 mol thiodiglycol or dihydroxyhexylsulfide, the di- and triisocyanates of the di- and trimer fatty acids, or mixtures of two or more of the aforesaid diisocyanates.

It is also possible to use as polyisocyanates trivalent or higher-valence isocyanates such as those obtainable, for example, by oligomerization of diisocyanates, in particular by oligomerization of the aforementioned isocyanates. Examples of such trivalent and higher-valence polyisocyanates are the triisocyanurates of HDI or IPDI or mixtures thereof, or mixed triisocyanurates thereof, as well as polyphenylmethylene polyisocyanate as obtainable by phosgenation of aniline-formaldehyde condensation products.

Polyethers that have been modified by vinyl polymers are also suitable for use as a polyol component. Products such as these are obtainable, for example, by polymerizing styrene and/or acrylonitrile, or a mixture thereof, in the presence of polyethers.

Polyester polyols having a molecular weight from approximately 200 to approximately 5000 can further be used as a polyol component for manufacturing the reactive diluent. It is thus possible, for example, to use polyester polyols that are produced by way of the reaction already described above between low-molecular-weight alcohols, in particular ethylene glycol, diethylene glycol, neopentyl glycol, hexanediol, butanediol, propylene glycol, glycerol, or trimethylolpropane, and caprolactone. Likewise suitable as polyfunctional alcohols for the manufacture of polyester polyols are, as already recited, 1,4-hydroxymethylcyclohexane, 2-methyl-1,3-propanediol, butanediol-1,2,4, triethylene glycol, tetraethylene glycol, polyethylene glycol, dipropylene glycol, polypropylene glycol, dibutylene glycol, and polybutylene glycol.

Other suitable polyester polyols can be manufactured by polycondensation. For example, difunctional and/or trifunctional alcohols can be condensed with a deficit of dicarboxylic acids and/or tricarboxylic acids, or reactive derivatives thereof, to yield polyester polyols. Suitable dicarboxylic and tricarboxylic acids, as well as suitable alcohols, have already been recited above.

Polyacetals are also suitable as a polyol component for manufacturing the reactive diluents. Polyacetals are understood to be compounds obtainable from glycols, for example diethylene glycol or hexanediol or a mixture thereof with formaldehyde. Polyacetals usable in the context of the invention can also be obtained by the polymerization of cyclic acetals.

Polycarbonates are also suitable as polyols for manufacturing the reactive diluents. Polycarbonates can be obtained, for example, by reacting diols, such as propylene glycol, butane-1,4-diol or hexane-1,6-diol, diethylene glycol, triethylene glycol or tetraethylene glycol, or mixtures of two or more thereof, with diaryl carbonates, for example diphenyl carbonate, or carbonyl dichloride.

Polyacrylates bearing OH groups are also suitable for use as a polyol component for manufacturing the reactive diluents. These polyacrylates are obtainable, for example, by polymerizing ethylenically unsaturated monomers bearing an OH group. Such monomers are obtainable, for example, by esterification of ethylenically unsaturated carboxylic acids and difunctional alcohols, the alcohol generally being present at a slight excess. Ethylenically unsaturated carboxylic acids suitable for this purpose are, for example, acrylic acid, methacrylic acid, crotonic acid, or maleic acid. Corresponding esters bearing OH groups are, for example, 2-hydroxyethyl acrylate, 2-hydroxyethyl methacrylate, 2-hydroxypropyl acrylate, 2-hydroxypropyl methacrylate, 3-hydroxypropyl acrylate, or 3-hydroxypropyl methacrylate, or mixtures of two or more thereof.

Solvents and/or plasticizers can also be used, alongside or instead of a reactive diluent, to reduce the viscosity of the adhesive and sealant formulation.

Aliphatic or aromatic hydrocarbons, halogenated hydrocarbons, alcohols, ketones, ethers, esters, ester alcohols, keto alcohols, keto ethers, keto esters, and ether esters are suitable as solvents. Alcohols are, however, used by preference, since shelf stability then rises. C₁ to C₁₀ alcohols, in particular methanol, ethanol, isopropanol, isoamyl alcohol, and hexanol, are preferred.

The preparation can further contain hydrophilic plasticizers. These serve to improve moisture uptake and thus to improve reactivity at low temperatures. Suitable as plasticizers are, for example, adipic acid esters, azelaic acid esters, benzoic acid esters, butyric acid esters, acetic acid esters; esters of higher fatty acids having approximately 8 to approximately 44 carbon atoms, esters of OH-group-carrying or epoxidized fatty acids, fatty acid esters and fats, glycolic acid esters, phosphoric acid esters, phthalic acid esters of linear or branched alcohols containing 1 to 12 carbon atoms, propionic acid esters, sebacic acid esters, sulfonic acid esters, thiobutyric acid esters, trimellitic acid esters, citric acid esters, and esters based on nitrocellulose and polyvinyl acetate, as well as mixtures of two or more thereof. The asymmetrical esters of adipic acid monooctyl ester with 2-ethylhexanol (Edenol DOA, Cognis Deutschland GmbH, Düsseldorf) are particularly suitable.

Suitable among the phthalic acid esters are, for example, dioctyl phthalate, dibutyl phthalate, or butylbenzyl phthalate, and among the adipates dioctyl adipate, diisodecyl adipate, diisodecyl succinate, or dibutyl sebacate or butyloleate.

Also suitable as plasticizers are the pure or mixed ethers of monofunctional, linear, or branched C₄₋₁₆ alcohols or mixtures of two or more different ethers of such alcohols, for example dioctyl ether (obtainable as Cetiol OE, Cognis Deutschland GmbH, Dusseldorf).

In a further preferred embodiment of the present invention, end-capped polyethylene glycols are used as plasticizers, for example di-C₁₋₄ alkyl ethers of polyethylene glycol or polypropylene glycol, in particular the dimethyl or diethyl ethers of diethylene glycol or dipropylene glycol, as well as mixtures of two or more thereof.

Particularly preferred, however, are end-capped polyethylene glycols such as dialkyl ethers of polyethylene glycol or polypropylene glycol, in which the alkyl residue contributes one to four carbon atoms, and in particular the dimethyl and diethyl ethers of diethylene glycol and dipropylene glycol. Acceptable curing even under less favorable application conditions (low relative humidity, low temperature) is achieved in particular with dimethyldiethylene glycol. For further details regarding plasticizers, the reader is referred to the relevant chemical engineering literature.

Also suitable in the context of the present invention as plasticizers are diurethanes, which can be manufactured e.g. by reacting diols having OH terminal groups with monofunctional isocyanates, by selecting the stoichiometry so that substantially all the free OH groups react completely. Any excess isocyanate can then be removed from the reaction mixture, for example, by distillation. A further method for manufacturing diurethanes involves reacting monofunctional alcohols with diisocyanates, such that if possible all the NCO groups react.

The adhesive or sealant can furthermore contain up to approximately 20 percent by mass of usual adhesion promoters. Suitable adhesion promoters are, for example, aminosilanes, for example silanes of formula (IV), resins, terpene oligomers, coumaron/indene resins, aliphatic petrochemical resins, and modified phenol resins. Suitable in the context of the present invention as adhesion promoters are, for example, hydrocarbon resins such as those obtained by the polymerization of terpenes, chiefly α- or β-pinenes, dipentenes, or limonenes. Polymerization of these monomers is generally performed cationically, with initiation using Friedel-Crafts catalysts. Also included among the terpene resins, for example, are copolymers of terpenes and of other monomers, for example styrene, α-methylstyrene, isoprene, and the like. The aforesaid resins are utilized, for example, as adhesion promoters for contact adhesives and coating materials. Also suitable are the terpene-phenol resins that are produced by acid-catalyzed addition of phenols to terpenes or colophon. Terpene-phenol resins are soluble in most organic solvents and oils, and are miscible with other resins, waxes, and rubber. Also suitable in the context of the present invention as an additive as recited above are the colophon resins and derivatives thereof, for example esters or alcohols thereof.

The adhesive or sealant can furthermore contain up to approximately 7 percent by mass, in particular up to approximately 5 percent by mass, antioxidants.

The adhesive or solvent can also contain up to approximately 2 percent by mass, by preference approximately 1 percent by mass, UV stabilizers. The so-called hindered amine light stabilizers (HALS) are particularly suitable as UV stabilizers. It is preferred in the context of the present invention if a UV stabilizer that carries a silyl group, and that is incorporated into the end product upon crosslinking or curing, is used. The products Lowilite 75, Lowilite 77 (Great Lakes company, USA) are particularly suitable for this purpose. Benzotriazoles, benzophenones, benzoates, cyanoacrylates, acrylates, sterically hindered phenols, phosphorus, and/or sulfur can also be added.

It is often useful to further stabilize the adhesives or sealants according to the present invention with regard to moisture penetration by means of drying agents, in order to enhance shelf life even further. Such improvement in shelf life can be achieved, for example, with the use of drying agents. Suitable as drying agents are all compounds that react with water to form a group that is inert with respect to the reactive groups present in the preparation, and in that context experience as little change as possible in their molecular weight. In addition, the reactivity of the drying agent with respect to moisture that has penetrated into the preparation must be greater than the reactivity of the terminal groups of the silyl-group-carrying polymer according to the present invention that is present in the preparation.

Isocyanates, for example, are suitable as drying agents.

In a preferred embodiment, however, silanes are used as a drying agent, for example vinylsilanes such as 3-vinylpropyltriethoxysilane, oximosilanes such as methyl-O,O′,O″-butan-2-onetrioximosifane or O,O′,O″,O′″-butan-2-onetetraoximosilane (CAS nos. 022984-54-9 and 034206-40-1) or benzamidosilanes such as bis(N-methylbenzamido)methylethoxysilane (CAS no. 16230-35-6) or carbamatosilanes such as carbamatomethyltrimethoxysilane. The use of methyl-, ethyl- or vinyltrimethoxysilane, tetramethyl- or -ethylethoxysilane is, however, also possible. Vinyltrimethoxysilane and tetraethoxysilane are particularly preferred here in terms of efficiency and cost.

The aforementioned reactive diluents are also suitable as drying agents, provided they have a molecular weight (Mₙ) of less than approximately 5000 g/mol and possess terminal groups whose reactivity with respect to moisture that has penetrated is at least as great as, preferably greater than, the reactivity of the reactive groups of the silyl-group-carrying polymer according to the present invention.

Lastly, alkyl orthoformates or alkyl orthoacetates can also be used as drying agents, for example methyl or ethyl orthoformate, methyl or ethyl orthoacetate.

The adhesives or sealants according to the present invention generally contain approximately 0 to approximately 6 percent by mass drying agent.

The adhesive or sealant according to the present invention is manufactured in accordance with known methods, by intimate mixing of the constituents in suitable dispersing equipment, e.g. in a high-speed mixer.

The invention also relates to the use of compounds of formula (I) as an additive in silane-crosslinking adhesives or sealants. The additive is preferably used to increase elasticity.

The invention also relates to the use of the adhesive or sealant according to the present invention for adhesive bonding of plastics, metals, glass, ceramic, wood, wood materials, paper, paper materials, rubber and textiles, adhesive bonding of floors, sealing of construction parts, windows, wall and floor coverings, and gaps in general. The respective materials can, in this context, be adhesively bonded to themselves or arbitrarily to one another. The invention will be further explained below with reference to exemplifying embodiments.

### EXAMPLE 1

Manufacturing a compound according to the present invention by reacting:

| | |
|---|---|
| 160.4 g | C12/14 fatty acid methyl ester (Cognis, Edenor ME C12-C14) |
| 239.6 g | 3-aminopropyltriethoxysilane (Wacker, Geniosil GF 93) |
| 6.2 g | Sodium methanolate solution (in ethanol, 21 percent by mass) |

For this the mixture is stirred at 80 to 90° C. for 4 hours under a nitrogen atmosphere, with precipitation of methanol. No purification of the end product occurs.

### EXAMPLE 2

Manufacturing a poly(propylene glycol) polymer that is terminally functionalized with alkoxysilyl groups:

1377.5 g polypropylene glycol 18000 (M=12,000 g/mol, OH number=9.6) was dried at 100° C. for one hour in vacuum in a 3000 ml three-necked glass flask. Under a nitrogen atmosphere, 0.4 g dibutyltin laurate and 6 g isocyanatopropyltrimethylsiloxane were added at 80° C. The reaction mixture was then stirred for 1 hour under a nitrogen atmosphere at 80° C. After cooling to approx. 35° C., the product was mixed with 29.8 g vinyltrimethoxysilane and introduced into a vessel sealed against moisture.

### EXAMPLES 3 TO 7

Mixtures having the compositions indicated below were produced, and the mechanical properties of the cured films per DIN 53504, as well as the tensile shear strength of adhesive bonds, were investigated

| | | Ex. 3 | Ex. 4 | Ex. 5 | Ex. 6 | Ex. 7 |
|---|---|---|---|---|---|---|
| Prepolymer (product of Example 2) | (g) | 26.40 | 23.40 | | 20.40 | |
| Product of Example 1 | (g) | | 3.00 | | 6.00 | |
| C12/14 fatty acid methyl ester (Cognis, Edenor ME C12-14) | (g) | | | 1.20 | | 2.40 |
| Aminopropyltriethoxysilane (Wacker, Geniosil GF 93) | (g) | | | 1.80 | | 3.60 |
| Vinyltrimethoxysilane (Wacker, Geniosil XL 10) | (g) | 0.50 | 0.50 | | 0.50 | |
| Aminopropyltrimethoxysilane (Wacker Geniosil GF96) | (g) | 0.26 | 0.26 | | 0.26 | |
| Dibutyltin laurate | (g) | 0.015 | 0.015 | | 0.015 | |
| Tensile shear strength, adhesive bond beech plywood | (N/mm²) | 2.8 | 3.7 | 3.1 | 4.5 | 3.9 |
| to beech plywood (100 mm/min) | | | | | | |
| Breaking strength | (N/mm²) | 0.7 | 1.00 | 0.8 | 1.8 | 1.5 |
| Elongation at fracture | (%) | 60 | 76 | 55 | 100 | 75 |
| Modulus, 50% elongation | (N/mm²) | 0.7 | 0.8 | 0.7 | 1.1 | 1.3 |

Tensile and Shear Strength Tests

1) Adhesive Bonding
Apply the adhesive with a fine-toothed spreader (produces 1×1 mm beads spaced 1 mm apart)
Secure the test articles to one another using two clothespins
Cure the adhesive bond in a standard climate (23° C., 50% RH) for 7 days

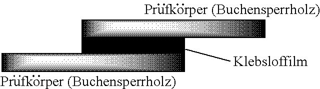

[Prüfkörper . . . =Test article (birch plywood)
Klebstoffilm=Adhesive film]

2) Tensile Test
Zwick Z 010 (10 kN tensile tester)
Extend at 10 mm per minute until adhesive bond breaks
The tensile shear strength is then the maximum force at breakage of the adhesive bond.

Example 3 shows, as a reference, the mechanical properties of a binder without the additive according to the present invention.

Examples 4 to 6 represent adhesives or sealants according to the present invention that contain the additive according to the present invention at increasing concentration. An increase in tensile shear strength is evident here, simultaneously with an increase in elongation at fracture, as a function of additive quantity.

Example 5 contains a composition equivalent to Example 4, except that the ester (per III) and silane (per IV) were not reacted with one another to yield the additive (per I). It is evident here that simple physical mixing of the components on which the additive is based shows much lesser effects.

The same is true analogously for the relationship between Example 7 and Example 6.

1. A silane-crosslinking adhesive or sealant containing a polymer made up of an organic backbone that carries at least two alkoxy- and/or acyloxysilyl groups, wherein, as further components, compounds of formula (I) 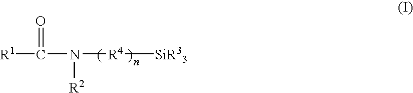
in which
R¹ is a straight-chain or branched, substituted or unsubstituted alkyl residue having 1 to 24 carbon atoms,
R² is a hydrogen residue or a straight-chain or branched hydrocarbon residue having 1 to 10 carbon atoms,
R³ is an alkoxy residue having 1 to 8 carbon atoms or an alkyl residue having 1 to 24 carbon atoms,
R⁴ is a straight-chain or branched alkylene residue having 1 to 8 carbon atoms, in which carbon atoms can be substituted with nitrogen or oxygen atoms,
n=1 to 8, preferably n=3 to 8,
such that the residues R³ can each be the same or different, and at least two of the residues are alkoxy residues,
are contained as an additive.

2. The adhesive or sealant according to claim 1, wherein R¹ is a straight-chain or branched, substituted or unsubstituted alkyl residue having 1 to 24 carbon atoms, which can contain OH groups or epoxy groups, and/or R² is a hydrogen, butyl, cyclohexyl, or phenyl residue, and/or R³ is a methoxy, ethoxy, or alkyl residue having 1 to 24 carbon atoms.

3. The adhesive or sealant according to claim 1 or 2, wherein the polymer corresponds to the general formula (II) 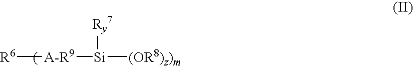
in which R⁶ is an organic backbone,
A signifies a double-bond bonding group,
R⁷ is an alkyl residue having 1 to 8 carbon atoms,
R⁸ is an alkyl residue having 1 to 8 carbon atoms or an acyl residue having 1 to 8 carbon atoms,
R⁹ is a straight-chain or branched, substituted or unsubstituted alkylene residue having 1 to 8 carbon atoms,
y=0 to 2,
z=3−y, and
m=1 to 10,000,
such that the silyl residues can be the same or different, and in the case of multiple residues R⁷ or R⁸, the latter can each be the same or different.

4. The adhesive or sealant according to claim 1, wherein the organic backbone is selected from the group encompassing polyamides, polyethers, polyesters, polycarbonates, polyethylenes, polybutylenes, polystyrenes, polypropylenes, polyacrylates, poly(meth)acrylates, polyoxymethylene homo- and copolymers, polyurethanes, vinyl butyrates, vinyl polymers, rayon, ethylene copolymers, ethylene-acrylic acid copolymers, ethylene-acrylate copolymers, organic rubbers, mixtures of different silylated polymers.

5. The adhesive or sealant according to claim 1, wherein the organic backbone is a polyether or polyurethane.

6. The adhesive or sealant according to claim 1, wherein R¹ is an alkyl residue having 10 to 16 carbon atoms, which can contain OH groups or epoxy groups.

7. The adhesive or sealant according to claim 1, wherein the compounds of formula (I) have been manufactured from an ester of formula (III) 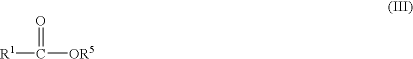
in which
R¹ is a straight-chain or branched, substituted or unsubstituted alkyl residue having 1 to 24 carbon atoms, and
R⁵ is a methyl or ethyl residue,
and a silane of formula (IV) 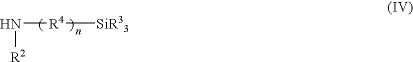
in which
R² is a hydrogen residue or a straight-chain or branched hydrocarbon residue having 1 to 10 carbon atoms,
R³ is an alkoxy residue having 1 to 8 carbon atoms or an alkyl residue having 1 to 24 carbon atoms,
R⁴ is a straight-chain or branched alkylene residue having 1 to 8 carbon atoms, in which carbon atoms can be substituted with nitrogen or oxygen atoms,
n=1 to 8, preferably n=3 to 8,
such that the residues R³ can each be the same or different, and at least two of the residues are alkoxy residues.

8. The adhesive or sealant according to claim 7, wherein the molar ratio of the compounds of formula (III) to compounds of formula (IV) is equal to 1:10 to 2:1, in particular 7:10 to 7:5.

9. The adhesive or sealant, containing a polymer according to claim 1, a vinylsilane, an aminosilane, an additive of formula (I) according to claim 1, and a catalyst.

10. The adhesive or sealant according to claim 9, wherein the proportion of compounds of formula (I) is equal to 0.1 to 50 percent by mass of the total binder content, in particular 5 to 30 percent by mass.

11. The adhesive or sealant according to claim 9, wherein the proportion of compounds of formula (I) is equal to 9 to 11 percent by mass of the total binder content.

12. (canceled)

13. (canceled)

14. (canceled)

15. (canceled)

16. The adhesive or sealant according to claim 1, wherein the polymer corresponds to the general formula (II) 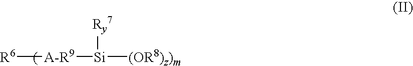
in which R⁶ is an organic backbone,
A is selected from amide, carbamate, urea, carbamoyl group, oxygen atom, nitrogen atom, or a methylene group,
R⁷ is an alkyl residue having 1 to 4 carbon atoms,
R⁸ is an alkyl residue having 1 to 4 carbon atoms or an acyl residue having 1 to 4 carbon atoms,
R⁹ is a straight-chain or branched, substituted or unsubstituted alkylene residue having 1 to 8 carbon atoms,
y is 0 to 2,
z is 3−y, and
m is 1 to 10,000,
such that the silyl residues can be the same or different, and in the case of multiple residues R⁷ or R⁸, the latter can each be the same or different.

17. The adhesive or sealant according to claim 1, wherein the polymer corresponds to the general formula (II) 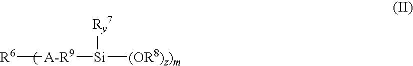
in which R⁶ is polypropylene glycol,
A is selected from amide, carbamate, urea, carbamoyl group, oxygen atom, nitrogen atom, or a methylene group,
R⁷ is an alkyl residue having 1 to 4 carbon atoms,
R⁸ is an alkyl residue having 1 to 4 carbon atoms or an acyl residue having 1 to 4 carbon atoms,
R⁹ is a straight-chain or branched, substituted or unsubstituted alkylene residue having 1 to 8 carbon atoms,
y is 0 to 2,
z is 3−y, and
m is 1 to 10,000,
such that the silyl residues can be the same or different, and in the case of multiple residues R⁷ or R⁸, the latter can each be the same or different.

18. An article comprising a substrate and cured reaction products of the silane-crosslinking adhesive or sealant of claim 1 bonded thereto.

19. The article of claim 18 wherein the substrate comprises plastic, metal, glass, ceramic, wood, wood material, paper, paper material, rubber or textile.

20. The article of claim 18 further comprising a second substrate bonded to the first substrate by cured reaction products of the silane-crosslinking adhesive or sealant of claim 1.
